(19) United States
(12) Patent Application Publication
(10) Pub. No.: US 2006/0156348 A1
(43) Pub. Date: Jul. 13, 2006

(54) Control apparatus and method

(75) Inventor: Akihiro Tanabe, Minato-ku (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/303,679

(22) Filed: Dec. 16, 2005

(30) Foreign Application Priority Data
Dec. 28, 2004 (JP) 2004-381608

(51) Int. Cl. H04N 7/18

(52) U.S. Cl. 725/74; 709/231; 386/124; 340/3.1; 710/33

(57) ABSTRACT

A control apparatus comprises a digital interface for connecting to an external apparatus; a judging unit adapted to judge whether the external apparatus connected via the digital interface can perform streaming; and a communication unit adapted to issue a request for transferring streaming to the external apparatus if it is judged that the external apparatus can perform streaming, and adapted to issue no request for transferring streaming to the external apparatus if it is judged that the external apparatus cannot perform streaming.

### BACKGROUND OF THE INVENTION

1. Field of the Invention

The present invention relates to a control apparatus for controlling an external apparatus such as a digital video camcorder or the like, and a method used in the control apparatus.

2. Description of Related Art

A USB (Universal Serial Bus) is one of techniques for transferring video data (see “Universal Serial Bus Specification Revision 2.0, Apr. 27, 2000, pp. 15 to 24”). The USB defines a synchronous transfer system called isochronous in order to assure a transfer of a moving image in real time. A host controller transmits a synchronous signal called start of frame (SOF) to each of devices connected thereto. The device transferring a moving image transfers video data on a bus in synchronism with the SOF, thereby making it possible to assure real-time property. The device transferring isochronous data has to ensure a frequency band for the transfer. Each device issues a descriptor to the host controller to notify it of an alternate setting interface indicating the frequency band necessary for the transfer of the isochronous data, whereby the host controller selects the alternate setting interface for each device by Set_Interface request, thereby ensuring the frequency band.

In a system where a transfer of streaming data is started at the same time as the start-up of an application, there arises a problem of wasteful use of frequency band when it is unnecessary for the application to transfer the streaming data. Supposing, for example, that an image capture apparatus and a PC are connected with a USB interface, in which a recording request command is issued to the PC by pushing down a recording button of the image capture apparatus and an application of the PC receiving the issued command stores the streaming data being transferred onto a storage medium. In the above-mentioned system, it may be considered that the recording request command cannot be used when the recording button on the connected image capture apparatus is pushed. In this case, the application cannot achieve its function, with the result that receiving the streaming data wastefully uses frequency band.

### SUMMARY OF THE INVENTION

According to an aspect of the present invention, a control apparatus comprises: a digital interface for connecting to an external apparatus; a judging unit adapted to judge whether the external apparatus connected via the digital interface can perform streaming; and a communication unit adapted to issue a request for transferring streaming to the external apparatus if it is judged that the external apparatus can perform streaming, and adapted to issue no request for transferring streaming to the external apparatus if it is judged that the external apparatus cannot perform streaming.

According to another aspect of the present invention, a method for use in a control apparatus which controls an external apparatus, the method comprises the steps of: judging whether the external apparatus connected via a digital interface can perform streaming; issuing a request for transferring streaming to the external apparatus if it is judged that the external apparatus can perform streaming; and issuing no request for transferring streaming to the external apparatus if it is judged that the external apparatus cannot perform streaming.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the present invention and, together with the description, serve to explain the principles of the present invention.

FIG. 1 is a diagram showing one example of a descriptor;

FIG. 2 is a chart showing a structure of SET_INTERFACE request defined in a USB;

FIG. 3 is a chart showing an example of a descriptor held by a device defined by the USB;

FIG. 4 is a communication flow of isochronous transfer between a host and a device;

FIG. 5 is a view showing time-sequentially a state of a bus at the time of the isochronous communication;

FIG. 6 is a view showing a relationship in connection between the device defined by the USB and the host controller;

FIG. 7 is a view showing a flow of streaming of video data between a PC and an image capture apparatus;

FIG. 8 is a block diagram showing a configuration of a DVC that is one example of an image capture apparatus according to an embodiment of the present invention;

FIG. 9 is a view showing a connection between the DVC having the function of the embodiment and a PC;

FIG. 10 is a view showing a flow of process between the DVC and the PC;

FIG. 11 is a view showing a flow of process at the PC;

FIG. 12 is a view showing one example of a display;

FIG. 13 is a view showing one example of a display; and

FIG. 14 is a block diagram showing a configuration of a PC that is one example of a control apparatus according to the embodiment.

### DETAILED DESCRIPTION OF THE PREFERRED EMBODIMENTS

Preferred embodiments of the present invention will be explained with reference to drawings.

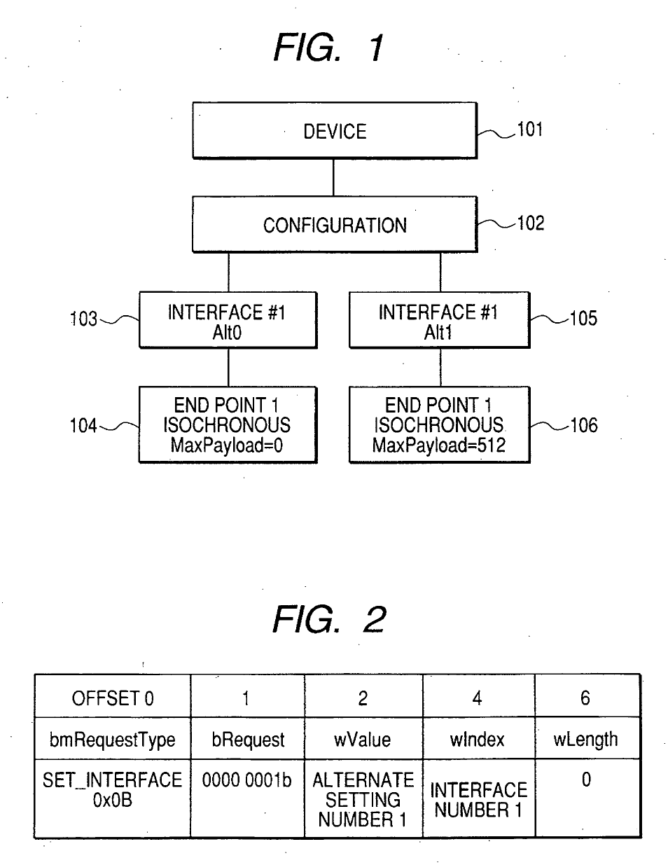

FIG. 1 is a diagram showing one example of a descriptor held by a device that isochronously transmits video data. The reference numeral 101 denotes a device descriptor for informing a vendor ID, product ID or the like. The reference numeral 102 denotes a configuration descriptor for informing a configuration that the device can take. The reference numeral 103 denotes a descriptor indicating an alternate setting 0 of an interface #1 used in the configuration 102. The reference numeral 104 denotes a descriptor of an end point used in the interface 103. Here, the Max Payload indicating a frequency band in an isochronous transfer type is 0. The reference numeral 105 denotes an interface descriptor indicating an alternate setting 1 of the interface #1. The reference numeral 106 denotes an end point descriptor in case that the interface #1 is set to the alternate setting 1, in which the Max Payload indicating the frequency band in the isochronous transfer type is 512 bytes.

Accordingly, a host controller selects the alternate setting number 1 of the interface number #1 according to the Set_Interface request shown in FIG. 2, whereby the data transfer of 512 bytes is ensured in (1 ms in USB Full Speed, 125 μs in High Speed) every SOF period, and hence, the device holding this descriptor can isochronously transmit data.

The USB has no definition of data in the isochronous transfer, so that any type of data may be transferred. Specifically, it is necessary to exchange data format or the like among devices. The device can notify, by the descriptor, the stream data to be isochronously transferred, to the host controller to which the stream data format is to be transferred.

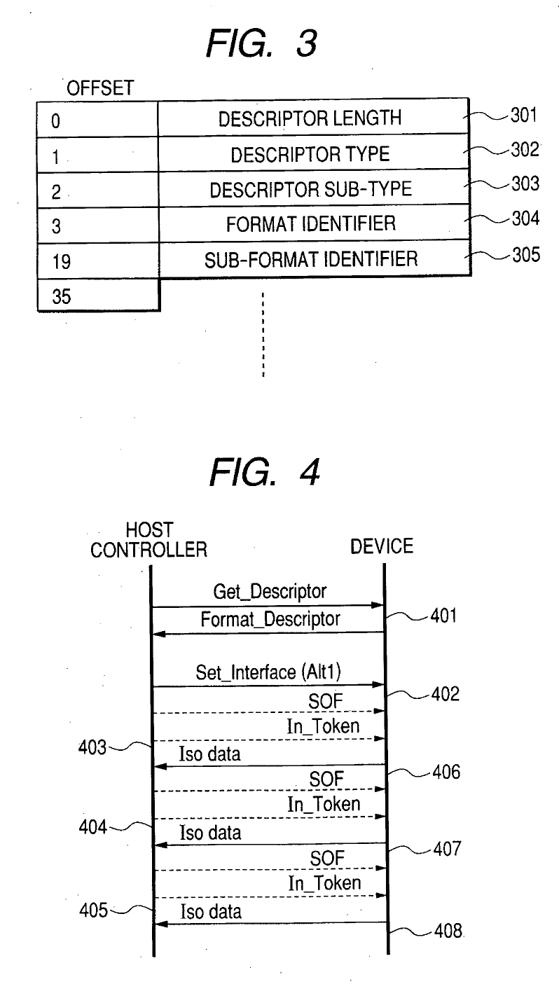

FIG. 3 is an example of a descriptor used for notifying a stream format to be transferred to the host controller by the device. The reference numeral 301 denotes a descriptor length. The reference numerals 302 and 303 denote a type and sub-type of the descriptor, i.e., denote that the descriptor is for notifying the streaming format. The reference numerals 304 and 305 denote identifiers indicating a stream format and sub-format transmitted as isochronous data. The host controller reads this value to recognize the stream format transmitted from the device that holds the descriptor shown in FIG. 3, thereby enabling processing of received stream data.

FIG. 4 is a view simply showing a data flow when image data is flown on the USB between the host controller and the device. The host controller obtains the descriptor indicating the stream format from the device, by using a command of Get_Descriptor (time 401). Subsequently, the host controller changes the alternate setting number to 1 by a command of Set_Interface (time 402). Then, the host controller transmits In_Token packet to the device for every SOF (times 403 to 405), while the device transmits the actual isochronous data (times 406 to 408) to the host controller after receiving In_Token packet, if the device has the data to be transferred.

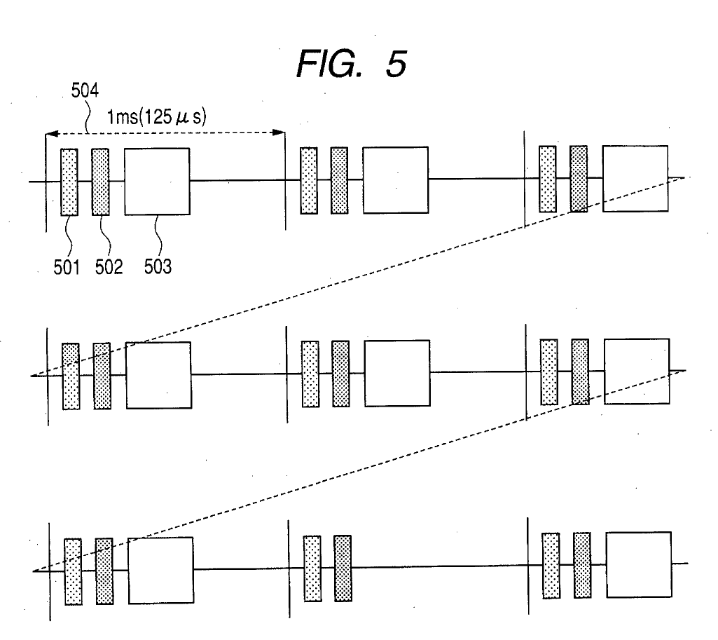

FIG. 5 is a view time-sequentially showing a data flow on the USB. The SOF 501 is transmitted from the host controller for every 1 ms (125 μs in the case of High Speed) (504), and then, the In_Token packet 502 is similarly transmitted to the isochronous end point of the device from the host controller. When there is data to be transmitted subsequent to the In_Token packet 502, the device transmits a data packet 503 via the isochronous end point. The device can transmit data in accordance with the In_Token packet every cycle. However, when the data transmission is impossible at the point of time 505, it is possible for the device not to transmit data at the present time but transmit data at the next cycle.

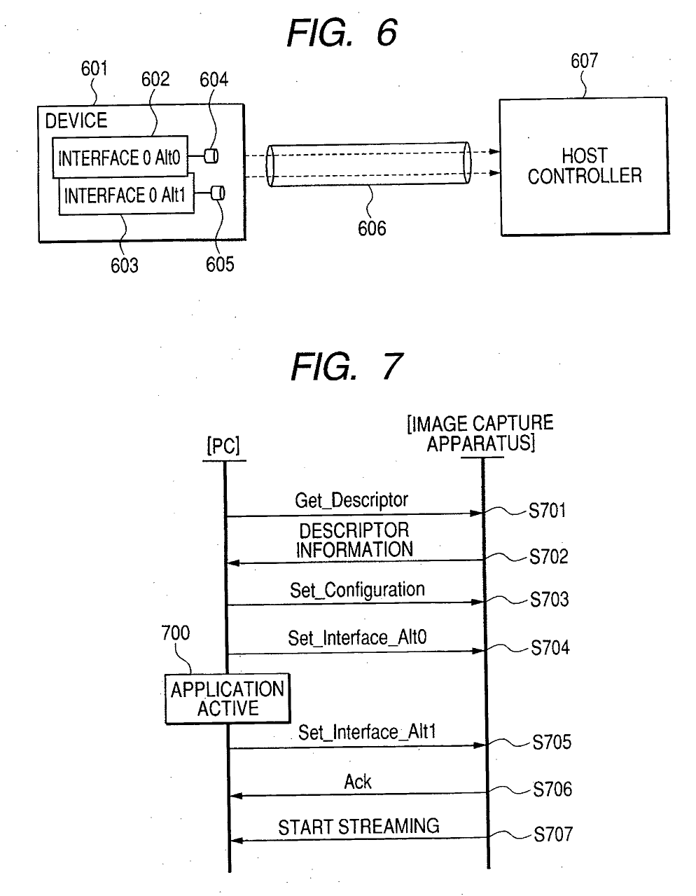

FIG. 6 is a view showing a connection relationship between the device 601 defined by the USB and the host controller 607. When a real-time data transfer is performed by the USB interface, it is necessary to secure a bus frequency band for transfer to ensure real-time property. This will be explained with reference to FIG. 6. As described above, in the USB interface, the frequency band is secured by the Max Payload set at the end point 604 having an attribute of isochronous transfer associated with the USB interface 602 held by the device 601. In the example of FIG. 6, when the alternate setting 603 of the interface 602 is selected by SET_INTERFACE standard request, the Max Payload of the end point 605 is set to 512 bytes, so that the data transferred to the host controller 607 via the end point 605 is as much as 512 bytes for every SOF. In this case, the data transfer up to 512 bytes is possible from a pipe 606 of the end point 605. Thus, when the alternate setting is not set to 1 (603) but to 0 (602) by the SET_INTERFACE standard request, the data transfer cannot be performed. However, the frequency band that the other devices can freely use is increased, since the frequency band of bus is not secured.

FIG. 7 shows a flow of streaming between a PC (personal computer) and an image capture apparatus. The PC corresponds to a host controller, while the image capture apparatus corresponds to a device. A connection is established between the PC and the image capture apparatus via the USE interface. When an application for displaying an image on a camera captured by the image capture apparatus on the PC is started, it is necessary to perform a display setting of the image on the camera. This will be explained with reference to FIG. 7. After a connection is established between the PC and the image capture apparatus, the PC issues GET_Descriptor request to the image capture apparatus to obtain descriptor information of the image capture apparatus (S701). The image capture apparatus receiving this request gives the descriptor information to the PC (S702). Actually, the GET_Descriptor request is issued in accordance with a descriptor type such as device configuration, or the like. After obtaining all pieces of descriptor information, the PC issues Set_Configuration to the image capture apparatus to select and set an optional configuration. Since an ordinary device has only one configuration, a default configuration is selected (S703). Subsequently, when the target image capture apparatus has an interface for streaming data, the PC issues Alternate Setting 0 of Set_Interface, so that the alternate setting becomes 0 (the setting by which the transfer of the streaming data is not performed) (S704). When the PC activates the application (700) for displaying the camera image of the image capture apparatus, the application issues to the image capture apparatus Alternate Setting 1 of Set_Interface to display the streaming data, thereby giving a request for the streaming data transmission of the alternate 1 (S705). When accepting this request, the image capture apparatus transmits Ack that is a receipt notice to the PC (S706), thereby transferring the video data to the PC in real time in accordance with the streaming format set by the alternate setting 1 (S707).

The above is the flow of the streaming transfer in a general system. However, the transfer of the streaming data is started in simultaneous with the start-up of the application, so that, if the application does not need to transfer the streaming data, there arises a problem of wastefully using frequency band. Supposing, for example, that an image capture apparatus and a PC are connected with a USB interface, in which a recording request command is issued to the PC by pushing down a recording button of the image capture apparatus and an application of the PC receiving the issued command stores the streaming data being transferred onto a storage medium. In the above-mentioned system, it may be considered that the recording request command cannot be used when the recording button on the connected image capture apparatus is depressed. In this case, the application cannot achieve its function, with the result that receiving the streaming data wastefully uses frequency band. This embodiment described below aims to avoid the aforesaid problem.

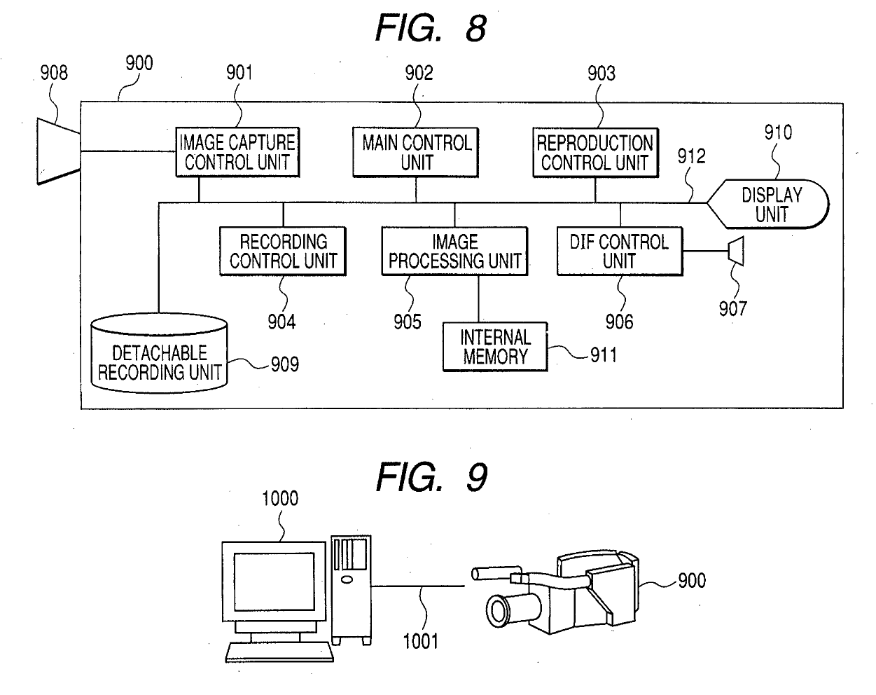

FIG. 8 is a block diagram showing a configuration of a digital video camcorder (hereinafter referred to as DVC) 900 that is one example of the image capture apparatus of the embodiment according to the present invention. In FIG. 8, upon recording, an image capture control unit 901 controls an image pickup element 908 to capture video image and still image of an object. The video image and still image captured by the image pickup element 908 are compressed at an image processing unit 905 to appropriate video image and still image format. The compressed data is transferred to and recorded into a detachable recording unit 909 by a recording control unit 904. On the other hand, upon the reproduction, the image and the still image recorded on the detachable recording unit 909 are read by a reproduction control unit 903, and expanded by the image processing unit 905 in accordance with the appropriate video image and still image format. The expanded data is transferred to a display unit 910 and displayed thereon. An internal memory 911 is connected in the image processing unit 905. Further, when an external apparatus (host controller) is connected to the digital interface 907, the video image and still image data compressed by the image processing unit 905 are output via the digital interface 907 by a DIF control unit 906. The digital interface 907 is a USB interface or IEEE 1394 interface. The control units are connected to one another via a data/address bus 912. The data transfer is performed via this bus 912. A main control unit 902 controls each control unit.

FIG. 9 is a view for showing a connection between the DVC 900 and the PC 1000. The DVC 900 corresponds to the DVC 900 in FIG. 8, and is connected to the PC 1000 via the USB interface 1001. The PC 1000 corresponds to a host controller, while the DVC 900 corresponds to a device. In accordance with the procedure shown in FIG. 7, the PC 1000 obtains the image captured by the DVC 900 in real time via the USB interface 1001. The DVC 900 in this embodiment has one interface for the streaming data, and has alternate setting 0 and alternate setting 1 of the interface. In the alternate setting 0, the band frequency is 0, so that the streaming data cannot be transferred. In the alternate setting 1, the band frequency is secured, so that the streaming data can be transferred. When the DVC 900 is connected to the PC 1000 via the USB interface, the DVC 900 has a function (hereinafter referred to as DV controller function) of issuing a request to record on a tape media, if a tape is inserted, and a request to record to the PC 1000 depressing a recording or recording stop button of the DVC 900. The PC 1000 has a function (hereinafter referred to as DV recording application) of performing a recording or stopping a recording to the storage medium of the PC 1000 in receipt of the recording request or recording stop request from the connected DVC 900.

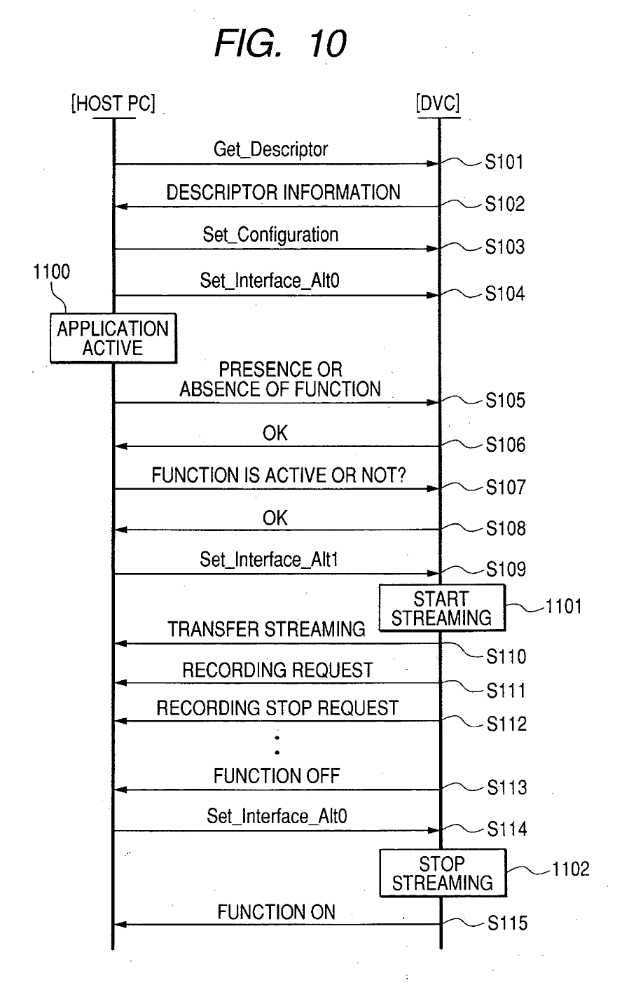

FIG. 10 shows an overall flow in this embodiment. When the PC is connected to the DVC via the USB interface, the PC, that is a host controller, recognizes that the DVC, that is a device, is connected, and then, issues Get_Descriptor request to obtain detailed information of the connected device (S101). The DVC receiving the Get_Descriptor request transmits the descriptor information to the PC (S102). The processes at S101 and S102 for obtaining the descriptor are continued until all descriptors are obtained. The PC obtaining the descriptor information issues Set_Configuration request to set a configuration (S103). Subsequently, if the PC knows from the read descriptor information that the DVC has an interface for streaming data, which interface is a logical block for flowing the streaming data, it issues a request of Set_Interface Alternate Setting 0 that is a command for setting the alternate setting to 0 in which the streaming data is set not to be flowed (S104). The DVC receiving this command sets the setting of the interface to alternate setting 0.

When the above-mentioned DV recording application installed to the PC is activated after the above negotiation is completed (Step 1100), the PC issues a command for judging whether the DVC has the above-mentioned DV controller function or not (S105). When the DVC has the DV controller function, the DVC returns a response notice of status OK indicating that it has the function (S106), while if the DVC does not have the function, it returns a status indicating that it does not have the function. After receiving the response of status OK from the DVC, the PC further issues a status command for knowing whether the DV controller function is active or not (S107). If the function is active (on), the DVC receiving the status command returns a response notice indicating that the function is active (S108). After the response indicating that the function is active is returned, the PC issues to the DVC Alternate Setting 1 of Set_Interface for changing the setting to the one for transferring the streaming data, regardless of the presence or absence of the recording request (S110). The DVC receiving the request sets the setting of the interface to the alternate setting 1, thereby starting the streaming of the video data (Step 1101) and transferring the streaming data to the USB interface with the isochronous synchronous transfer (S110). The PC starting the receipt of the streaming data only displays the streaming data of the transferred image and does not perform a recording on a recording media, until it receives the recording request from the DVC. Thereafter, the PC records on the recording media the streaming data (video data) transferred after receiving the recording request from the DVC (S111). Then, when receiving the recording stop request from the DVC, the PC stops the recording of the streaming data on the recording media (S112). When a user changes the DV controller function of the DV to OFF after a while, the DVC issues a notice of OFF of the DV controller to the PC (S113). The PC receiving this notice issues the Alternate Setting 0 of the Set_Interface in order not to wastefully use frequency band, thereby making the frequency band for the isochronous transfer of the alternate setting 0 free (S114). Thus, this can prevent the waste use of the frequency band. The DVC receiving the Alternate Setting 0 of the Set_Interface stops the data transfer (Step 1102). Thereafter, when the user changes the DV controller function of the DVC to ON, the DVC issues a notice of ON of the DV controller function to the PC (S115). Then, the processes similar to the processes at S109 and the following are executed.

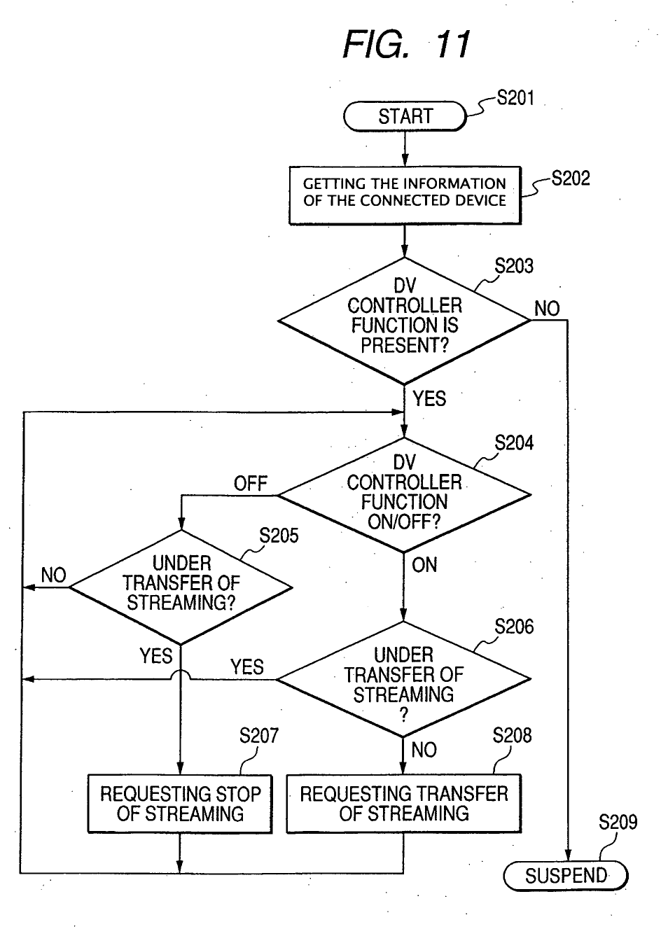

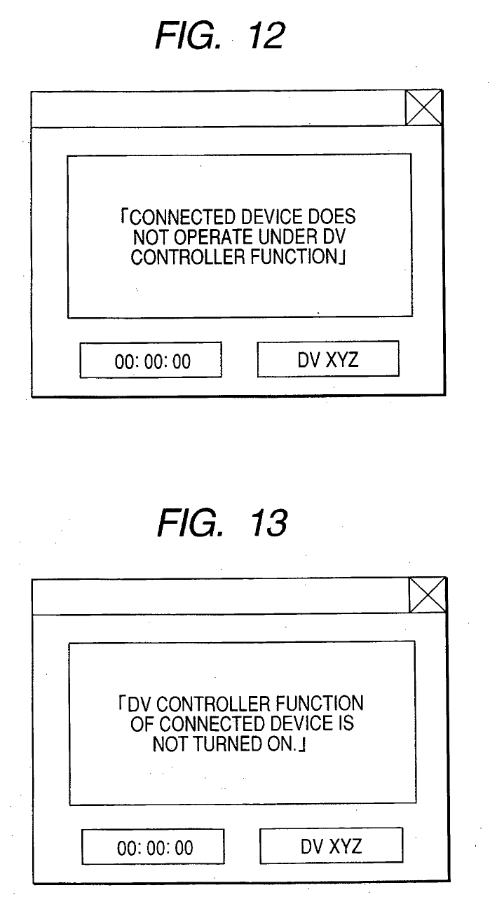

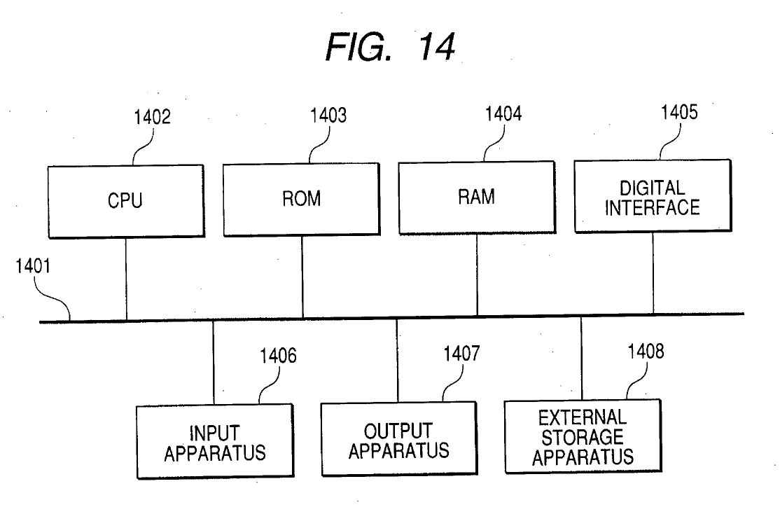

FIG. 11 shows a process of the PC that is the host controller. The PC, that is the host controller, obtains the information of the connected device (S202) after the bus reset (S201). Thereafter, the PC issues a command for confirming the presence of the DV controller function, thereby making a judgment (S203). When it is judged that the device has no DV controller function, the PC does not perform a display and moves into a suspend state, since displaying the streaming thereafter entails confusion of the user and results in wastefully using frequency band (S209). It should be noted that the PC displays a message indicating that the device does not have the DV controller function, such as a message of “the connected device does not operate under DV controller function” as shown in FIG. 12. On the other hand, when it is judged that the device has the DV controller function, the PC judges whether the DV controller function is turned ON or OFF (S204). When the DV controller function is ON as a result of the judgment, the PC judges whether the streaming data is being transferred or not (S206). If the streaming data is under transfer, the PC proceeds to the step S204 of judging the ON/OFF of the DV controller function, while if not, the PC issues a request for transferring the streaming data (video data) (S208). It should be noted that, when the DV controller function is OFF, the PC displays a message indicating that the DV controller function is turned off, such as a message indicating that “DV controller function of connected device is not turned ON” or the like as shown in FIG. 13. When the DV controller function is judged to be turned OFF at step S204, the PC judges whether the streaming data is under transfer or not (S205). If the streaming data is under transfer, the PC issues a request of a stop of the streaming (S207) If not, the PC checks again the ON/OFF of the DV controller function (S204).

Either one of the notice by the interrupt transfer defined by the USB and status polling by the PC can be used as means for reporting to the PC by the DVC the above-mentioned recording request, recording stop request, and the ON/OFF information of the DV controller.

FIG. 14 is a block diagram showing a configuration of a PC 1000 that is one example of the control apparatus according to this embodiment. Connected to a bus 1401 are a central processing unit (CPU) 1402, a ROM 1403, a RAM 1404, a digital interface 1405, an input apparatus 1406, an output apparatus 1407 and an external storage apparatus 1408.

The CPU 1402 executes data processing and operation, and controls the above-mentioned each unit connected via the bus 1401. A boot program is stored beforehand in the ROM 1403. The CPU 1402 executes this boot program, thereby starting the computer. A computer program is stored in the external storage apparatus 1408. This computer program is copied to the RAM 1404 and executed by the CPU 1402. This computer executes the computer program to perform the process shown in FIG. 11. The process shown in FIG. 11 may be executed by the hardware of the digital interface 1405 or by software of a communication driver.

The external storage apparatus 1408 is, for example, a hard disc storage apparatus. Even if the power is turned off, the content stored in the external storage apparatus does not disappear. The external storage apparatus 1408 can record a computer program and video data on a recording medium, or can read the computer program and video data from the recording medium.

The digital interface 1405 is, for example, a USB interface or the like. It is connectable to the DVC 900 and can send or receive video data to or from the DVC 900. Further, the digital interface 1405 is a network interface. It can send or receive a computer program or the like to or from the network. The input apparatus 1406 is, for example, a keyboard, pointing device (mouse) or the like. It can perform various designations or inputs. The output apparatus 1407 is a display, printer, or the like. It outputs the message or the like shown in FIGS. 12 and 13.

This embodiment can be realized by the execution of the program by the computer. Further, the present invention is applicable to means for supplying a program to a computer, examples of which include a computer-readable recording medium such as CD-ROM or the like having the program recorded thereon, or a transfer medium such as Internet or the like for transferring the program. Moreover, a computer program product such as the computer-readable recording medium having the program recorded thereon can be applied as the embodiment of the present invention. The aforesaid program, recording medium, transfer medium and computer program product can be included in the scope of the present invention. Examples of usable recording medium include a flexible disk, a hard disk, an optical disk, a magneto-optical disk, a CD-ROM, a magnetic tape, a non-volatile memory card, a ROM, or the like.

As described above, the PC and the DVC has the USB interface and the function of sending or receiving streaming data according to this embodiment. The above-described DVC includes the alternate setting 0 in which the streaming data is set not to be flowed, and the alternate setting 1 in which the streaming data is allowed to be flowed, in the interface that is capable of flowing the streaming data. The alternate setting can be switched over from the PC connected via the USB interface. The PC has a function for changing the alternate setting 0 and the alternate setting 1 for the streaming transfer on the DVC via the USB interface. Moreover, the DVC has a function of issuing the recording request to the PC via the USB interface by depressing the recording button. The PC has a function of receiving the streaming data transferred from the DVC and recording the same on the recording medium in receipt of the recording request. The PC obtains a status for judging whether the DVC makes the recording request issuing function active or not. When the status is active, the PC sets the alternate setting 1 to issue the transfer command of the streaming data. When the status is not active, the PC sets the alternate setting 0 so as not to perform the streaming of video data.

In this embodiment, a PC and DVC have a USB interface. When these apparatuses are connected via the USB, the DVC has a logical function block called interface for streaming. A single interface has plural alternate settings that can be changed over. When the alternate setting is 0, the interface for streaming is in a state in which streaming is not flowed. When the alternate setting is 1 or more, it can flow the streaming having the setting described in the setting information of the device, called descriptor. When the PC receives the reproduction command when the alternate setting is 0, the PC returns Stall to the reproduction command, and when the alternate setting is set to 1, the PC performs a transfer to the DVC from the beginning of the content. Further, the receipt of the streaming is the same as described above. Specifically, when the alternate setting is 0, the PC is in a state in which it cannot receive streaming from the DVC. When the alternate setting is 1 or more, the PC can receive streaming. When the PC receives the recording command when the alternate setting is 0, the PC returns Stall in response to the recording command. On the other hand, the PC issues SET_INTERFACE command, which is a standard command of USB, to the DVC having the interface for streaming, whereby the alternate setting of the interface for streaming can be switched over.

According to this embodiment, the wasteful use of frequency band can be prevented by setting an alternate setting of an interface to 0, in the case of the absence of streaming function of video data or in the case of turn-off of this function.

A streaming of video data is explained above-described embodiments, but the present invention is not limited thereto. A DVC may be an image capture apparatus such as a digital camera, a cellular phone equipped with camera, or the like. A control apparatus (PC) has judging means for judging whether an image capture apparatus (DVC) connected via a digital interface can perform streaming or not; and communication means that issues a request of transfer of streaming when the image capture apparatus can perform streaming, and the communication means that does not issue a request of transfer of streaming when the image capture apparatus cannot perform streaming.

Furthermore, the USB interface is explained above-described embodiments, but the present invention is not limited thereto. Any digital interface can be used to satisfied above-described embodiments.

The above-described embodiments are merely exemplary of the present invention, and are not be construed to limit the scope of the present invention.

The scope of the present invention is defined by the scope of the appended claims, and is not limited to only the specific descriptions in this specification. Furthermore, all modifications and changes belonging to equivalents of the claims are considered to fall within the scope of the present invention.

This application claims priority from Japanese Patent Application No. 2004-381608 filed Dec. 4, 2004, which is hereby incorporated by reference herein.

What is claimed is:

1. A control apparatus comprising:
a digital interface for connecting to an external apparatus;
a judging unit adapted to judge whether the external apparatus connected via the digital interface can perform streaming; and
a communication unit adapted to issue a request for transferring streaming to the external apparatus if it is judged that the external apparatus can perform streaming, and adapted to issue no request for transferring streaming to the external apparatus if it is judged that the external apparatus cannot perform streaming.

2. The apparatus according to claim 1, wherein the judging unit judges whether the external apparatus connected via the digital interface has a function of issuing a recording request of video data, and
wherein the communication unit issues a transfer request of the video data to the external apparatus if the external apparatus has the function of issuing the recording request, and issues no transfer request of the video data to the external apparatus if the external apparatus does not have the function of issuing the recording request.

3. The apparatus according to claim 2, wherein the judging unit judges whether the function of the external apparatus of issuing the recording request is ON or OFF if the external apparatus has the function of issuing the recording request, and
wherein the communication unit issues the transfer request of the video data to the external apparatus if the function of issuing the recording request is ON, and issues no transfer request of the video data to the external apparatus if the function is OFF.

4. The apparatus according to claim 1, wherein the judging unit judges whether a function of the external apparatus, which is connected via the digital interface, of issuing a recording request of video data is ON or OFF, and
wherein the communication unit issues a transfer request of the video data to the external apparatus if the function of issuing the recording request is ON, and issues no transfer request of the video data to the external apparatus if the function is OFF.

5. The apparatus according to claim 1, wherein the digital interface is a USB interface.

6. The apparatus according to claim 1, wherein the external apparatus is an image capture apparatus.

7. A method for use in a control apparatus which controls an external apparatus, comprising the steps of:
judging whether the external apparatus connected via a digital interface can perform streaming;
issuing a request for transferring streaming to the external apparatus if it is judged that the external apparatus can perform streaming; and
issuing no request for transferring streaming to the external apparatus if it is judged that the external apparatus cannot perform streaming.
